(19) United States
(12) Patent Application Publication
(10) Pub. No.: US 2026/0064103 A1
(43) Pub. Date: Mar. 5, 2026

(54) SYSTEMS AND METHODS FOR DEVICE ADVISORS

(71) Applicant: Sensia Netherlands B.V., Rotterdam (NL)

(72) Inventors: Jeffery P. Anderson, Beaumont (CA); Thony Brito Cardier, Dubai (AE); Srikanth G. Mashetty, Houston, TX (US); Norman Andrew Weatherhead, Kitchener (CA); Harshkumar Patel, Houston, TX (US); Aquib Mustafa, Houston, TX (US); Ryan McDonald, Houston, TX (US); Jonathan Wun Shiung Chong, Calgary (CA)

(73) Assignee: Sensia Netherlands B.V., Rotterdam (NL)

(21) Appl. No.: 19/267,184

(22) Filed: Jul. 11, 2025

Related U.S. Application Data
(60) Provisional application No. 63/690,664, filed on Sep. 4, 2024.

(51) Int. Cl. G05B 19/418; G06F 16/3329

(52) U.S. Cl. CPC G05B 19/41835; G06F 16/3329

(57) ABSTRACT

A system includes an edge device and a computing platform. The computing platform includes one or more processors and one or more non-transitory computer-readable media storing program instructions that cause the one or more processors to perform operations including fine-tuning, a plurality of advisor models to perform different types of advisor operations for an oil-and-gas facility using data relating to oil-and-gas equipment, sorting, a user query to a first advisor model by selecting, by at least one machine learning model, the first advisor model from the plurality of advisor models based on a content of the user query, generating, by the first advisor model, an actionable response to the user query, and causing the oil-and-gas facility to operate in accordance with the actionable response.

### CROSS-REFERENCE TO RELATED APPLICATIONS

The present application claims priority to U.S. Provisional Patent App. No. 63/690,664 filed on Sep. 4, 2024, the disclosure of which is incorporated herein by reference in its entirety for all purposes.

### BACKGROUND

The present disclosure relates generally to industrial devices, for example controllers and other devices in industrial systems. More specifically, the present disclosure relates to systems and methods to advising and improving operation of devices in industrial systems, such as an oil-and-gas facility.

### SUMMARY

At least one implementation of the present disclosure is directed to a system. The system includes an edge device and a computing platform. The computing platform includes one or more processors and one or more non-transitory computer-readable media storing program instructions that, when executed by the one or more processors, cause the one or more processors to perform operations including fine-tuning a plurality of advisor models to perform different types of advisor operations for an oil-and-gas facility using data relating to oil-and-gas equipment, sorting a user query to a first advisor model by selecting, by at least one machine learning model, the first advisor model from the plurality of advisor models based on a content of the user query, generating, by the first advisor model, an actionable response to the user query, and causing the oil-and-gas facility to operate in accordance with the actionable response.

At least one implementation of the present disclosure is directed to a method for an oil-and-gas facility. The method can include fine-tuning a plurality of advisor models to perform different types of advisor operations for an oil-and-gas facility using data relating to oil-and-gas equipment, sorting a user query to a first advisor model by selecting, by at least one machine learning model, the first advisor model from the plurality of advisor models based on a content of the user query, generating, by the first advisor model, an actionable response to the user query, and causing the oil-and-gas facility to operate in accordance with the actionable response.

At least one implementations of the present disclosure is directed toa system. The system can include an edge device, a user interface, and a computing platform configured to assist operation of the edge device, the computing platform comprising one or more processors and one or more non-transitory computer-readable media storing program instructions that, when executed by the one or more processors, cause the one or more processors to perform operations including in response to receiving a user query from the user interface, providing, using at least one machine learning model, the user query to an advisor model of a plurality of advisor models based at least partially on a content of the user query, the plurality of advisor models to perform different types of advisor operations for an oil-and-gas facility using data relating to oil-and-gas equipment. The operations can include generating, by the advisor model, an actionable response to the user query. The operations can include causing the user interface to display the actionable response.

### BRIEF DESCRIPTION OF THE DRAWINGS

FIG. 1 is a perspective view of a hydrocarbon site equipped with well devices, according to some embodiments.

FIG. 2 is a block diagram of a control system for the hydrocarbon site of FIG. 1, according to some embodiments.

FIG. 3 is a block diagram of a portion of the control system of FIG. 2, showing a converged controller communicating with field equipment, input devices, and output devices, according to some embodiments.

FIG. 4 is a block diagram of a system including the converged controller and a computing platform, according to some embodiments.

FIG. 5 is a block diagram of a computing platform, which can be implemented by the system of FIG. 4, according to some embodiments.

FIG. 6 is a block diagram of another computing platform, which can be implemented by the system of FIG. 4, according to some embodiments.

FIG. 7 is a block diagram of another computing platform, which can be implemented by the system of FIG. 4, according to some embodiments.

FIG. 8 is a flow diagram of a method for displaying an actionable response, according to some embodiments.

FIG. 9 is a flow diagram of a method for operating an actionable response, according to some embodiments.

FIG. 10 is a flow diagram of a method for updating a machine learning model, according to some embodiments.

### DETAILED DESCRIPTION

Before turning to the FIGURES, which illustrate certain exemplary embodiments in detail, it should be understood that the present disclosure is not limited to the details or methodology set forth in the description or illustrated in the FIGURES. It should also be understood that the terminology used herein is for the purpose of description only and should not be regarded as limiting.

Referring generally to the FIGURES, a device advisor can be installed on one or more edge devices, converged controllers, field controllers, or any other device used to monitor and operate oil-and-gas facilities (e.g., oil extraction site). The present disclosure relates generally to assisting users in identifying issues, improving functionality, and providing training for the device, which can be, for example, one or more edge devices. A user can be presented with two categories once they access the device advisor based on devices the device advisor is connected to. The options may include recommended actions that can be implemented directly by the device advisor. The options may also include recommended actions to be performed by the user. The options may be sorted by priority. For example, the device advisor can implement changes by identifying parameter modifications to improve performance of the device (e.g., edge device), send a message to the user requesting approval, and then the device advisor can directly implement the parameter modifications on the device. An example of physical intervention can be troubleshooting of connectivity issues where the device advisor provides troubleshooting steps based on the user prompt. However, recommendations may be performed by the user. Another example may be a recommendation by the device advisor to replace a sensor or a device. Another example may be that the device advisor can receive an image of a specific physical installation or screenshot along with an optional user prompt such as “please help me troubleshoot this” or “what should I do next”, identify any issues with the installation or configuration, and instruct the user on troubleshooting or how to proceed.

Approaches herein can provide various functionalities of the device advisor to enhance a user experience and operation of the device. For example, the device advisor can provide training tools for an unexperienced user to gain knowledge on how to use the device. The device advisor can also review assets and devices under the control of the user and recommend knowledge topics that may be useful to the user. In some embodiments, the device advisor can include a user query processer which receives a user query, and then sorts the user query to a plurality of advisor models. For example, responsive to the user query requesting current data of the device, the user query processor can sort the user query to an operational advisor model which can output the current data for the user on a user interface. The device advisor can also save a state of the device advisor from a last session interaction. A user can choose to continue with the last session or start a new session with the device advisor. Responsive to the user being unsatisfied with recommendations provided by the device advisor, the user has an option to trigger a process to directly contact an expert (e.g., support). Responsive to contacting the expert, a transcript of the user interaction with the device advisor which includes the recommended actions, may be forwarded to an expert. The expert can then review the transcript and communicate directly with the user.

While the systems and methods disclosed can be used to monitor, control, and improve industrial equipment, the systems and methods can also be used for advising devices for a variety of implementations such as manufacturing equipment. The systems and methods herein can continually update and improve with continued user usage and input.

### Hydrocarbon Site Overview

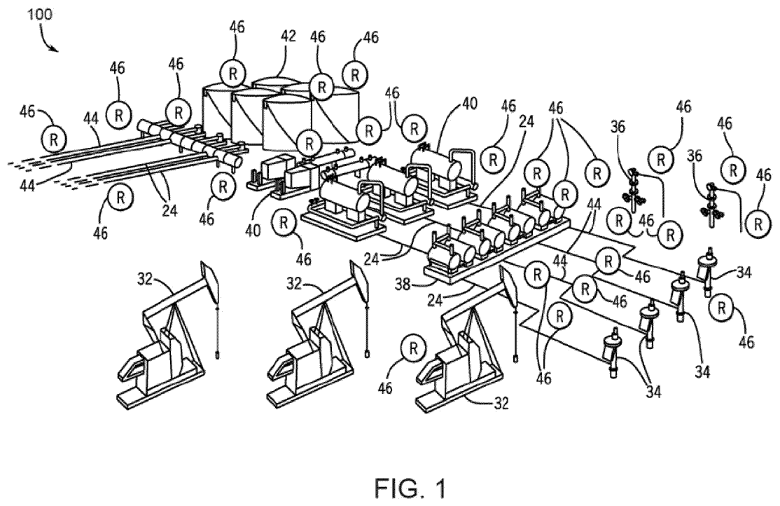

Referring now to FIG. 1, a hydrocarbon site 100 (e.g., an oil-and-gas facility) can be an area in which hydrocarbons, such as crude oil and natural gas, can be extracted from the ground, processed, and/or stored. As such, the hydrocarbon site 100 can include a number of wells and a number of well devices that can control the flow of hydrocarbons being extracted from the wells. In one embodiment, the well devices at the hydrocarbon site 100 can include any device equipped to monitor and/or control production of hydrocarbons at a well site. As such, the well devices can include pumpjacks 32, submersible pumps 34, well trees 36, and other devices for assisting the monitoring and flow of liquids or gases, such as petroleum, natural gasses and other substances. After the hydrocarbons are extracted from the surface via the well devices, the extracted hydrocarbons can be distributed to other devices such as wellhead distribution manifolds 38, separators 40, storage tanks 42, and other devices for assisting the measuring, monitoring, separating, storage, and flow of liquids or gasses, such as petroleum, natural gasses and other substances. At the hydrocarbon site 100, the pumpjacks 32, submersible pumps 34, well trees 36, wellhead distribution manifolds 38, separators 40, and storage tanks 42 can be connected together via a network of pipelines 44. As such, hydrocarbons extracted from a reservoir can be transported to various locations at the hydrocarbon site 100 via the network of pipelines 44.

The pumpjack 32 can mechanically lift hydrocarbons (e.g., oil) out of a well when a bottom hole pressure of the well is not sufficient to extract the hydrocarbons to the surface. The submersible pump 34 can be an assembly that can be submerged in a hydrocarbon liquid that can be pumped. As such, the submersible pump 34 can include a hermetically sealed motor, such that liquids cannot penetrate the seal into the motor. Further, the hermetically sealed motor can push hydrocarbons from underground areas or the reservoir to the surface.

The well trees 36 or Christmas trees can be an assembly of valves, spools, and fittings used for natural flowing wells. As such, the well trees 36 can be used for an oil well, gas well, water injection well, water disposal well, gas injection well, condensate well, and the like. The wellhead distribution manifolds 38 can collect the hydrocarbons that can have been extracted by the pumpjacks 32, the submersible pumps 34, and the well trees 36, such that the collected hydrocarbons can be routed to various hydrocarbon processing or storage areas in the hydrocarbon site 100.

The separator 40 can include a pressure vessel that can separate well fluids produced from oil and gas wells into separate gas and liquid components. For example, the separator 40 can separate hydrocarbons extracted by the pumpjacks 32, the submersible pumps 34, or the well trees 36 into oil components, gas components, and water components. After the hydrocarbons have been separated, each separated component can be stored in a particular storage tank 42. The hydrocarbons stored in the storage tanks 42 can be transported via the pipelines 44 to transport vehicles, refineries, and the like.

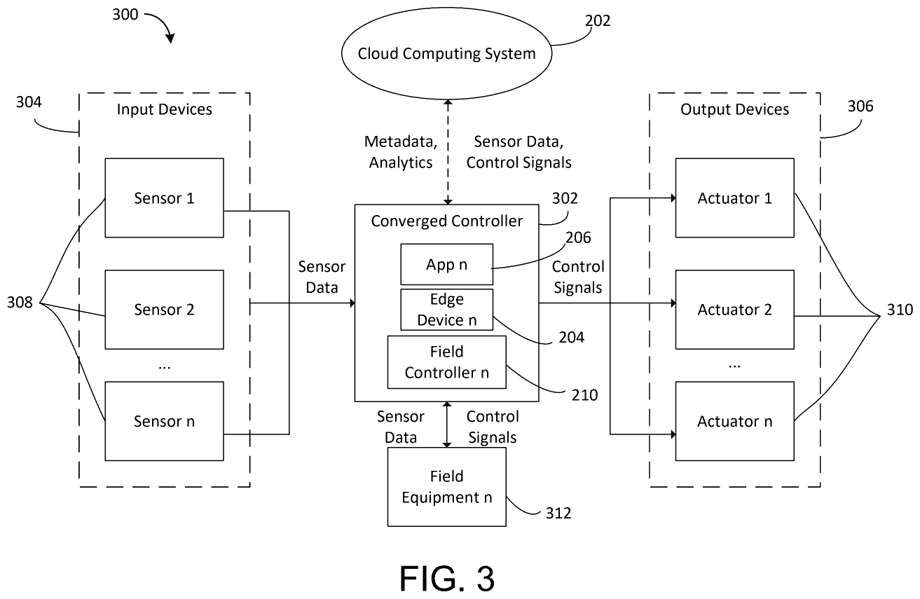

The well devices can also include monitoring systems that can be placed at various locations in the hydrocarbon site 100 to monitor or provide information related to certain aspects of the hydrocarbon site 100. As such, the monitoring system can be a controller, a remote terminal unit (RTU), or any computing device that can include communication abilities, processing abilities, and the like. For discussion purposes, the monitoring system will be embodied as the RTU 46 throughout the present disclosure. However, it should be understood that the RTU 46 can be any component capable of monitoring and/or controlling various components at the hydrocarbon site 100. The RTU 46 can include sensors or can be coupled to various sensors that can monitor various properties associated with a component at the hydrocarbon site 100. In some embodiments, one or more of the RTUs 46 of FIG. 1 are configured as one or more converged controllers 302 as shown in FIG. 3 and described below.

The RTU 46 can then analyze the various properties associated with the component and can control various operational parameters of the component. For example, the RTU 46 can measure a pressure or a differential pressure of a well or a component (e.g., storage tank 42) in the hydrocarbon site 100. The RTU 46 can also measure a temperature of contents stored inside a component in the hydrocarbon site 100, an amount of hydrocarbons being processed or extracted by components in the hydrocarbon site 100, and the like. The RTU 46 can also measure a level or amount of hydrocarbons stored in a component, such as the storage tank 42. In certain embodiments, the RTU 46 can be iSens-GP Pressure Transmitter, iSens-DP Differential Pressure Transmitter, iSens-MV Multivariable Transmitter, iSens-T2 Temperature Transmitter, iSens-L Level Transmitter, or Isens-1O Flexible 1/0 Transmitter manufactured by vMonitor® of Houston, Texas.

In one embodiment, the RTU 46 can include a sensor that can measure pressure, temperature, fill level, flow rates, and the like. The RTU 46 can also include a transmitter, such as a radio wave transmitter, which can transmit data acquired by the sensor via an antenna or the like. The sensor in the RTU 46 can be wireless sensors that can be capable of receive and sending data signals between RTUs 26. To power the sensors and the transmitters, the RTU 46 can include a battery or can be coupled to a continuous power supply. Since the RTU 46 can be installed in harsh outdoor and/or explosion-hazardous environments, the RTU 46 can be enclosed in an explosion-proof container that can meet certain standards established by the National Electrical Manufacturer Association (NEMA) and the like, such as a NEMA 4X container, a NEMA 7X container, and the like.

The RTU 46 can transmit data acquired by the sensor or data processed by a processor to other monitoring systems, a router device, a supervisory control and data acquisition (SCADA) device, or the like. As such, the RTU 46 can enable users to monitor various properties of various components in the hydrocarbon site 100 without being physically located near the corresponding components. The RTU 46 can be configured to communicate with the devices at the hydrocarbon site 100 as well as mobile computing devices via various networking protocols.

In operation, the RTU 46 can receive real-time or near real-time data associated with a well device. The data can include, for example, tubing head pressure, tubing head temperature, case head pressure, flowline pressure, wellhead pressure, wellhead temperature, and the like. In any case, the RTU 46 can analyze the real-time data with respect to static data that can be stored in a memory of the RTU 46. The static data can include a well depth, a tubing length, a tubing size, a choke size, a reservoir pressure, a bottom hole temperature, well test data, fluid properties of the hydrocarbons being extracted, and the like. The RTU 46 can also analyze the real-time data with respect to other data acquired by various types of instruments (e.g., water cut meter, multiphase meter) to determine an inflow performance relationship (IPR) curve, a desired operating point for the wellhead 30, key performance indicators (KPis) associated with the wellhead 30, wellhead performance summary reports, and the like. Although the RTU 46 can be capable of performing the above-referenced analyses, the RTU 46 cannot be capable of performing the analyses in a timely manner. Moreover, by just relying on the processor capabilities of the RTU 46, the RTU 46 is limited in the amount and types of analyses that it can perform. Moreover, since the RTU 46 can be limited in size, the data storage abilities can also be limited.

In certain embodiments, the RTU 46 can establish a communication link with the cloud-based computing system 12 described above. As such, the cloud-based computing system 12 can use its larger processing capabilities to analyze data acquired by multiple RTUs 26. Moreover, the cloud-based computing system 12 can access historical data associated with the respective RTU 46, data associated with well devices associated with the respective RTU 46, data associated with the hydrocarbon site 100 associated with the respective RTU 46 and the like to further analyze the data acquired by the RTU 46. The cloud-based computing system 12 is in communication with the RTU via one or more servers or networks (e.g., the Internet).

In some embodiments, the best operating point of a submersible downhole pump can be determined by performing an optimization process. For example, model-based optimization or artificial intelligence can be used in order to determine an operating point (i.e., operating pressure, flow, and/or speed of the pump). In some embodiments, the optimization process can include determining the set of wells and the corresponding pump operating points in order to hit a certain production constraint while operating efficiently. In some embodiments, the best operating point can be transmitted to a motor optimization system.

### Site Control System

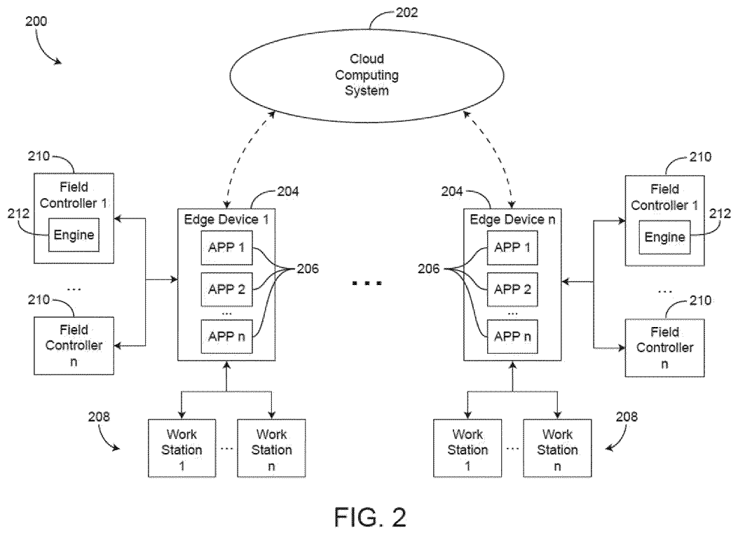

Referring particularly to FIG. 2, control system 200 for hydrocarbon site 100 is shown, according to some embodiments. In some embodiments, control system 200 includes or is configured to communicate with cloud computing system 202 and is configured to control various operations of a well site (e.g., hydrocarbon site 100) based on analyzing metadata from various devices within control system 200. Cloud computing system 202 may include any processing circuitry, processors, memory, etc., or combination thereof that are positioned remotely from hydrocarbon site 100. In various embodiments, some or all of the processing circuitry, processors, memory, etc., or combination thereof within cloud computing system 202 may be performed by various devices disclosed within control system 200. Control system 200 is further shown to include edge devices 204, and workstations 208, and field controllers 210. Edge device (n) 204, workstation (n) 208, and field controller (n) 210 as seen in FIG. 2 indicate any number of the edge device 204, workstation 208, and field controller 210 can be implemented in the control system 200.

While cloud computing system 202 is generally disclosed herein as performing some or all of the functionality of the methods disclosed herein, cloud-based architecture (e.g., cloud computing system 202 connected to edge device(s) 204 and field controller 210, etc.) is purely an exemplary embodiment and is not intended to be limiting. In some embodiments, the methods disclosed herein may be implemented by systems that do not include or utilize a cloud-based computing system (e.g., cloud computing system 202). In some embodiments, the systems and methods disclosed herein are architecture agnostic, such that they may be implemented across a variety of architectures including private or on-premise server infrastructure.

Edge devices 204 may be configured to run, perform, implement, store, etc., one or more applications 206 thereof. Application (n) 206 indicates any number of the application 206 can be run on the edge devices 204. Additionally, some or all processing circuitry, processors, memory, etc. included in various devices within control system 200 (e.g., edge device 204, field controller 210, workstation 208, etc.) may be distributed across several other devices within control system 200 or integrated into a single device. Edge device(s) 204 may be configured to receive data from field controller(s) 210 and provide data analytics to cloud computing system 202 based on the received data. This is described in greater detail below with reference to FIG. 3.

In some embodiments, each edge device 204 includes a processing circuit having a processor and memory. The processor can be a general purpose or specific purpose processor, an application specific integrated circuit (ASIC), one or more field programmable gate arrays (FPGAs), a group of processing components, or other suitable processing components. The processor is configured to execute computer code or instructions stored in the memory or received from other computer readable media (e.g., CDROM, removable USB drive, network storage, a remote server, etc.), according to some embodiments.

In some embodiments, the memory can include one or more devices (e.g., memory units, memory devices, storage devices, etc.) for storing data and/or computer code for completing and/or facilitating the various processes described in the present disclosure. The memory can include random access memory (RAM), read-only memory (ROM), hard drive storage, temporary storage, non-volatile memory, flash memory, optical memory, or any other suitable memory for storing software objects and/or computer instructions. The memory can include database components, object code components, script components, or any other type of information structure for supporting the various activities and information structures described in the present disclosure. The memory can be communicably connected to the processor via the processing circuitry and can include computer code for executing (e.g., by the processor) one or more processes described herein.

In some embodiments, various edge device(s) 204 may include some or all functionality of remote terminal units (RTUs) (e.g., RTU 46). In various embodiments, edge device(s) 204 is not limited to the functionality of RTU's and can include other controller features. Similarly, RTU's, as described herein, may refer to any industrial edge controller which is programmable and/or capable of one or more applications, either individually or as a module within a broader system (e.g., system 200).

Field controllers 210 may be configured to control various operations at a well site and are communicably coupled with edge devices 204. In some embodiments, field controllers 210 are configured to operate (e.g., provide control signals to, provide setpoints to adjust setpoints or operational parameters thereof) field equipment (e.g., electric submersible pumps (ESPs), cranes, pumps, etc.) of hydrocarbon site 100. Field controllers 210 may be grouped into different sets based on which edge device 204 field controller 210 communicate with. In some embodiments, edge device(s) 204 are configured to exchange any sensor data, measurement data, meter data (e.g., flow meter data), storage data, maintenance data, control signals, setpoint adjustments, operational adjustments, diagnostic data, analytics data, meta data, etc., with field controllers 210. It should be understood that each edge device 204 can be associated with, corresponding to, etc., multiple field controllers 210.

In some embodiments, one or more of field controllers 210 can include a computing engine 212. Computing engine 212 can be configured to perform various control, diagnostic, analytic, reporting, meta data-related, etc., functions. Computing engine 212 can be embedded in one or more of field controller 210 or may be embedded at one or more of edge devices 204. In some embodiments, any of the functionality of computing engine 212 is distributed across multiple edge devices 204 and/or multiple field controllers 210. In some embodiments, any of the functionality of computing engine 212 is performed by cloud computing system 202.

Still referring to FIG. 2, workstations 208 may be configured to receive user instructions for controlling hydrocarbon site 100 and provide control signals to various devices via control system 200. Workstations 208 can include any desktop computer, laptop computer, personal computer device, user interface, personal computer device, etc., or any general computing device thereof. In some embodiments, multiple workstations 208 (e.g., an n number of workstations 208) are associated with each edge device 204, while in other embodiments, one or more of edge devices 204 are associated with a single work station 208.

In some embodiments, field controller(s) 210 may be configured to act as edge devices such that field controller(s) 210 perform additional processing (e.g., data analysis, mapping, etc.) prior to providing information to cloud computing system 202. In some embodiments, this decreases latency in information processing to cloud computing system 202. In other embodiments, edge device(s) 204 operate as traditional edge devices and perform significant storage and processing within control system 200 (e.g., on-site, at/near hydrocarbon site 100, etc.) to mitigate latency due to processing information in cloud computing system 202.

### Converged Controller System

Referring now to FIG. 3, control system 300 for performing control of output devices 306 based on input devices 304 is shown, according to exemplary embodiments. Control system 300 is shown to include a converged controller 302 including edge device 204, application 206, cloud computing system 202, field controller 210, field equipment 312 (e.g., oil-and-gas equipment), input devices 304, and output devices 306. Field equipment (n) 312 indicates that any number of the field equipment 312 can be included in the control system 300.

The converged controller 302 can be a device configured to function as and include the edge device 204 and the field controller 210. In some embodiments, the converged controller 302 includes all the functionality of the edge device 204 and the field controller 210. For example, the converged controller 302 can both control equipment and optimize performance of the equipment. The converged controller 302 can be, for example, a HCC2 controller manufactured by Sensia LLC in some embodiments. The HCC2 controller can include analog acquisition hardware and software. In some embodiments, the converged controller 302 includes wired or wireless communication interfaces (e.g., jacks, antennas, transmitters, receivers, transceivers, transmitters, wire terminals, etc.) for conducting data communications with various edge devices, RTUs, converged controllers, and/or cloud computing system 202. For example, the converged controller 302 can include a Wi-Fi transceiver, cellular, or mobile phone communication transceivers for communication via wireless communication network.

Input devices 304 may be configured to provide various sensor data and/or field measurements from hydrocarbon site 100 to the converged controller 302 for processing. For example, sensor 308 of input devices 304 is measuring the pump speed of pump 34. Sensor 308 provides the pump speed of pump 34 to converged controller 302 at regular intervals (e.g., continuously, ever minute, every 5 minutes, etc.). Input devices 304 may be connected wired or wirelessly to converged controller 302 or any other device within system 300. In some embodiments, input devices 304 are coupled to various site equipment (e.g., pumps, pump jacks, cranes, etc.) and provide operational data of their respective site equipment to converged controller 302.

In some embodiments, sensor(s) 308 refer to physical sensors (e.g., temperature sensors, flow sensors, etc.) and/or virtual sensors (e.g., inferential sensors, soft sensors, etc.). In some embodiments, virtual sensors provide identical or similar information as would a physical sensor, only via software applications. In some embodiments, virtual sensors learn to interpret the relationships between the different variables and observe readings from various instruments. For example, rather than implementing several physical sensors at a site (e.g., hydrocarbon site 100), one or more virtual sensors may be placed on a simulation model to achieve identical or similar results.

Output devices 306 may be configured to receive control signals from converged controller 302 and adjust operation based on the received control signals. For example, converged controller 302 determines that pump 34 is operating at a lower pump speed than is considered optimal. The converged controller 302 subsequently sends a control signal to actuator 310 to increase pump speed for pump 34. In some embodiments, output devices 306 are configured to act as any device (e.g., actuator, etc.) capable of adjusting operation of site equipment within hydrocarbon site 100. In some embodiments, various other field equipment (e.g., field equipment 312) include some or all of the functionality of input devices 304 and output devices 306 and provide sensor data and receive control signals from converged controller 302. As seen in FIG. 3, sensor (n) 308 and actuator (n) 310 indicates that any number of the sensor 308 and the actuator 310 can be included and used by the control system 300.

In some embodiments, control system 300 is configured to analyze various sets of data (e.g., metadata) to determine control schema that is optimal for hydrocarbon site 100. A significant amount of processing for this may be performed by converged controllers (e.g., converged controller 302), instead of processing all metadata analytics in the cloud, as processing the data in on-site or proximate edge devices can decrease latency compared to sending the data to cloud computing system 202 for processing. For example, sensors 308 provide metadata to converged controller 302. Converged controller 302 processes the data to determine the type of data and/or domain from which the data is received and analyzes the data. An application within converged controller 302 e.g., application 206) may analyze the metadata to make decisions about the control schema that would have been otherwise unnoticed by processing within control system 300. For example, application 206 may infer that the data received has been received by a flow meter sensor (e.g., sensor (1) 308), based on the patterns seen in the data and a prior data that converged controller 302 has analyzed. Application 206 may make inferences, predictions, and calculations based on current and/or past data.

In some embodiments, application 206 provides some or all of the data to cloud computing system 202 for further processing. Application 206 may be configured to make inferences about received data that improves the standardization of data analytics. For example, sensor (1) 308 and sensor (2) 308 may be flow sensors, but from different vendors. As such, sensor (1) 308 may provide data to field controller 210 in a different format than sensor (2) 308. However, application 206 of the converged controller 302 may still be able to standardize the data and determine that both sets of data are from flow sensors, despite the received data being in different formats (e.g., one data set is provided under resource description framework (RDF) specifications, one data set is provided as data objects, etc.). In various embodiments, allowing converged controller 302 to perform some or all of the metadata analytics allows for improved data analytics and control schema without significantly increasing processing latency.

In various embodiments, the control system 300 does not include the converged controller 302, and instead includes the edge device 204 and the field controller 210. The application 206 can then be installed on the edge device 204, and the edge device 204 and/or the field controller 210 can receive input and control the input devices 304 and the output devices 306 as well as the field equipment 312.

### Device Advisors

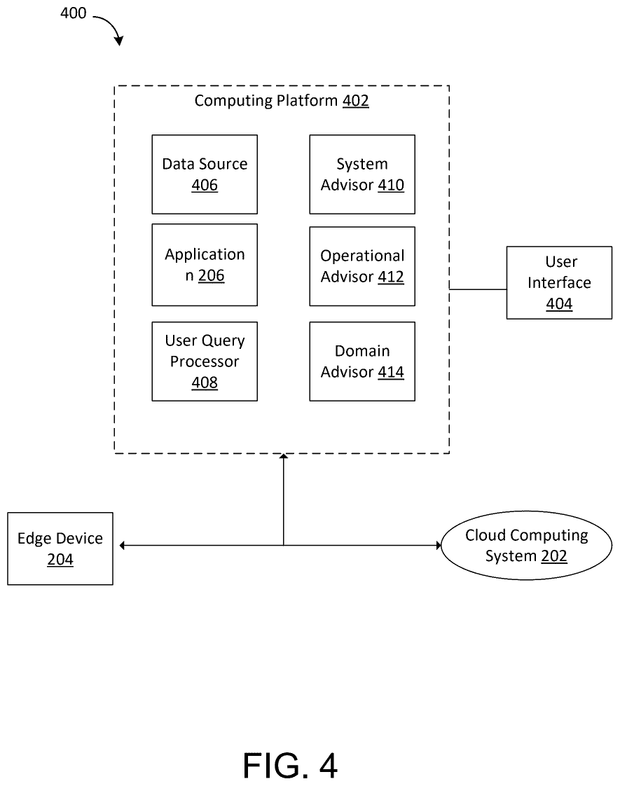

Referring now to FIG. 4, a system 400 is shown, according to some embodiments. System 400 is shown to include a computing platform 402, the cloud computing system 202, and the edge device 204. In some embodiments, the computing platform 402 is configured to assist in operations and management of the edge device 204. In some embodiments, the computing platform 402 is configured provide assistance to users of the edge device 204, a converged controller (e.g., the converged controller 302), and/or a field controller (e.g., field controller 210).

The system 400 can include one or more user interfaces 404. The user interface 404 can be an interface, HDMI interface, a screen, mobile device, etc., that provides supervisory control and user interaction capabilities to a user associated with the edge device 204. For example, the user interface 404 can be a touch screen mounted to the edge device 204 and allow for user input and control. In other embodiments, the user interface 404 is coupled to the cloud computing system 202. In this case, the user interface 404 can allow for remote monitoring and control of the field equipment 312. The user interface 404 can receive text, video, and/or image input.

Still referring to FIG. 4, the system 400 can include one or more computing platforms 402. The computing platform 402 can be configured to monitor, control, and improve functionality of the edge device 204. The computing platform 402 can utilize an enterprise data management (EDM) with industrial internet of things (IIoT) framework to operate the edge device 204, monitor the field equipment 312, etc. The computing platform 402 can include one or more processors and one or more non-transitory computer-readable medium storing program instructions to be executed by the one or more processors to provide the operations attributed to the computing platform 402 or its components herein. For example, the computing platform 402 can receive user input from the user interface 404 and execute an operation as indicated by the user as described further herein. Various functions described with reference to the components of the system 400 described further herein can be performed in various orders and/or combined or moved to other components of the system 400.

The computing platform 402 can include one or more data sources 406. The data sources 406 can include any of various databases, data sets, or data repositories, for example. The data source 406 can be maintained by one or more entities, which may be entities that maintain the system 400 or may be separate from entities that maintain the system 400. For example, the data source 406 can be maintained by the cloud computing system 202. The data source 406 can receive data from the user, third parties, and/or the cloud computing system 202. The data source 406 can include process automation, domain knowledge procedures, and application (e.g., application 206) documentation repository and source code. In addition, the data source 406 can include an application layer service domain which can include encapsulating security payload (ELS), port control protocol (PCP), global location (GL), and resource reservation protocol (RRP).

The computing platform 402 can include one or more user query processors 408. The user query processor 408 can be a machine learning model (e.g., generative AI). The user query processor 408 can be a large language model (LLM). The user query processor 408 can be a foundational multimodal LLM. The user query processor 408 can be trained by answers generated via various generative AI models as well as system manuals (e.g., manuals of the edge device 204). The user query processor 408 can receive a user query and respond to the user query. The user query can include text, image, and/or video (e.g., visual query). The user query can be a free-text query. The user query processor 408 can tokenize the user query, determine a context of the user query, and generate a response. The response to the user query can include an actionable response. The actionable response can be an action (e.g., task) to be performed by at least one of the users and/or the edge device 204 and/or the oil-and-gas facility. For example, the user query can be a question about improving performance of the field equipment 312. In response, the user query processor 408 can generate the actionable response which could include adjusting parameters of the field equipment 312. The parameters can then be adjusted by the edge device 204 and/or the field controller 210. In some embodiments, the actionable response can include parameter modifications for the edge device 204. The parameter modifications can be based on hyperparameters of the one or more advisor models. The hyperparameters of the one or more advisor models can reflect updated (e.g., current) edge device 204 performance constraints (e.g., processing power, data acquisition, etc.). The user query processor 408 can thus take into account the performance constraints of the edge device 204 to generate the actionable response (e.g., parameter modifications).

The computing platform 402 can include one or more advisor models (e.g., agentic AI models, agents, etc.). The advisor models are shown as being a system advisor 410, an operational advisor 412, and a domain advisor 414. The advisor models can be machine learning models (e.g., LLMs). The advisor models can be fine-tuned (e.g., adapted) by updating hyperparameters of the advisor models through continued user input (e.g., user interaction). The advisor models can also be fine-tuned by being fed prompt-based and/or interactive objective design and/or any other knowledge (e.g., data) in real-time for automation and control of the edge device 204 and/or the field equipment 312. For example, the hyperparameters of the advisor models can be adjusted to conform to performance requirements and constraint requirements of the hydrocarbon site 100. The hyperparameters can further be adjusted based on improved performance and/or multiple constraint handling under confliction of the field equipment 312. In this case, the hyperparameters are adjusted for dynamic problems where constraints and/or objectives of the field equipment 312 are to be turned in real-time with user interaction and/or input.

In some implementations, the advisor models can be an agent, such as an agentic artificial intelligence system. The advisor models can, for example, generate and execute an action. In other implementations, the advisor model can generate actions, and await user input prior to executing the action. In some implementations, the advisor model can generate and execute actions without user input.

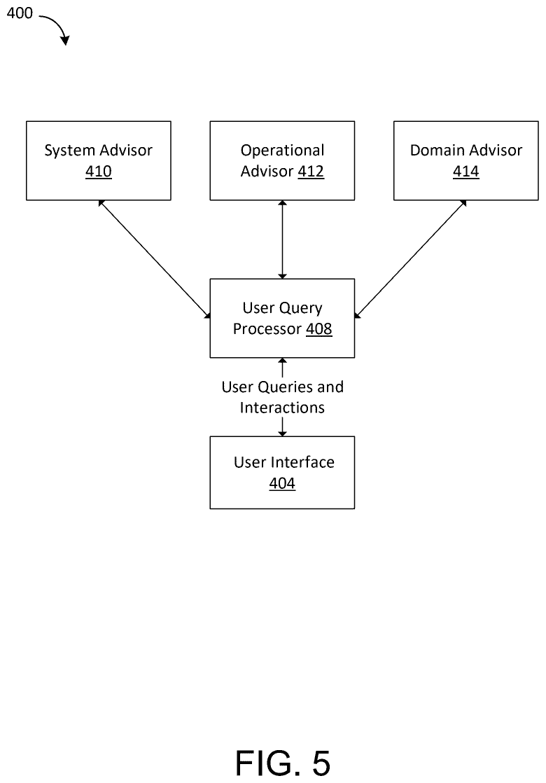

FIG. 5 depicts at least a portion of the system 400. The user query processor 408 can sort the user query to at least one of the advisor models to generate a response to the user query. The user query processor 408 can sort the user query based on a content and context of the user query. The advisor models can include at least one system advisor 410, operational advisor 412, and domain advisor 414. Each of the advisor models can perform different operations (e.g., different advisor operations), and the user query processor 408 can sort the query based on the operation that the advisor model performs. For example, the system advisor 410 can include a machine learning model configured to perform advisor operations. The advisor operations can include configuring the edge device 204 (e.g., installing the edge device 204) and assisting in developing applications for the edge device 204 (e.g., where an application should be installed). For example, given a user query regarding application development, the user query processor 408 directs the user query to be processed by the system advisor 410. The operational advisor 412 can include a machine learning model configured to perform advisor operations. The advisor operations can further include proposing improvements to and monitoring the edge device 204 (e.g., adjusting parameters and monitoring edge device 204 performance). The domain advisor 414 can include a machine learning model configured to perform advisor operations. The advisor operations can include providing training for the edge device 204 to users (e.g., via the user interface 404). The domain advisor 414 can be continuously updated and fine-tuned based on feedback received during training. For example, the domain advisor 414 can be updated based on user input received while providing training to the user.

The system advisor 410 can develop workflows that enable audit capabilities (e.g., can identify errors in the system 400) and assist in application (e.g., application 206) load balancing and value recognition (e.g., determining application deployment). For example, the system advisor 410 can identify which device and/or geographical location the application 206 should be installed at and identify what level of architecture the application 206 should be executed at (e.g., hardware layer, user interface 404, etc.). Furthermore, the system advisor 410 can take into account processing capabilities of the edge device 204, networking and telecommunication constraints (e.g., bandwidth, quality of service (QoS), latency, etc.), and data center resources availability when determining where the application 206 should execute. The system advisor 410 can also assist users in developing the application 206.

In some embodiments, the system advisor 410 develops (e.g., generates using generative artificial intelligence) workflows including a workflow steps, for example based on data sources 406. In some such embodiments, the data source 406 can include a set of steps and/or a plurality of the sets of steps (e.g., steps taken in equipment workflows such as commissioning workflows, installation workflows, troubleshooting workflows, process improvement workflows, and the like), and the system advisor 410 can extract the set of steps from the data source 406. In this case, each of the steps in the set of steps can be associated to variables within the application 206 (e.g., data collection rate), and the user can select steps from the set of steps to determine which of the variables to display on the user interface 404. For example, the user can select the variables to display as results, inputs, sequences, and/or record results through the user interface 404 via the set of steps. The user interface 404 can also display the workflow of the set of steps selected by the user and/or generated by the system advisor 410 (e.g., steps to be taken by the user, steps being taken by the system advisor 410 or other element of the system 400, details on how the system advisor 410 is extracting the variables and displaying the variables on the user interface 404). In various embodiments, the system advisor 410 can also capture login information, date, time, and other such information to store in the data source 406 and/or to display on the user interface 404. The steps can be accumulated into a document, database, or table, among others and uploaded to at least one of the data sources 406, the computing platform 402, and/or the cloud computing system 202.

In some embodiments, the system advisor 410 can generate an application based on a prompt. In this case, the system advisor 410 can include generation artificial intelligence (AI), and the user query can be a prompt. The prompt can provide instructions, objectives, and/or goals for the application. The system advisor 410 can generate an application (e.g., using generative AI to create software code that, when executed, provides the application) based on the prompt, and can also deploy the application to a target edge device. The target edge device can be determined based on the goals and/or a purpose of the application. The system advisor 410 can also consider processing constraints, a geographical location, and a type of oil-and-gas facility the target edge device is located at.

The system advisor 410 can detect additional devices (e.g., edge devices, converged controllers, etc.) added to the system 400, and reconfigure the system 400 accordingly (e.g., adjust power allocation). For example, the user query processor 408 can sort the query containing a question regarding an impact of adding another edge device to the system 300. The user query processor 408 can then sort the query to the system advisor 410, which can then calculate the impact and display a result to the user via the user interface 404. The system advisor 410 can also monitor the additional devices and record data produced by the additional devices. Based on the data and information of the additional devices, the system advisor 410 can develop training for users for the additional devices. For example, the system advisor 410 can generate templates for applications 206 for the additional devices and/or develop tools to operate the additional devices.

The operational advisor 412 can provide the user with interaction to the edge device 204 via the user interface 404. The operational advisor 412 can monitor the edge device 204 and troubleshoot problems arising from the edge device 204 and/or improve workflows of day to day activities (for example, by adjusting operational parameters used by edge devices 204, adjusting operating schedules for a facility, adjusting maintenance schedules, adjusting facility demands or loads, adjusting workflows executed by facility staff, etc.). For example, the operational advisor 412 can detect an irregularity in gas flow rate of the field equipment 312 by monitoring the edge device 204 and can alert the user to the irregularity. This can be in response to the user query requesting information regarding the gas flow rate. The operational advisor 412 can also execute actionable responses produced by the user query processor 408. For example, the operational advisor 412 can update parameters of the edge device 204 based on hyperparameters of the operational advisor 412 and/or control the field equipment 312. The operational advisor 412 can change a setting used by the edge device 204 based on the actionable response and control the field equipment 312 using the setting. For example, the operational advisor 412 can shut off the field equipment 312. The settings can include sensor reading, data logging, pulse width modulation (PWM), relay and actuator control, adjusting edge computing software, etc.

The operational advisor 412 can be fine-tuned by prompt-based (e.g., user query-based) and/or interactive objective design (e.g., objective constraints) or any other knowledge that can be fed in real-time for automation and control of, for example, the edge device 204. In this case, the operational advisor 412 can capture performance and constraint requirements of the edge device 204 by tuning hyperparameters of the operational advisor 412. In various embodiments, the hyperparameters of the operational advisor 412 can be tuned by a fine-tuned LLM model (e.g., the user query processor 408). For example, the user query processor 408 can receive queries regarding updated performance requirements of the edge device 204 and adjust the hyperparameters of the operational advisor 412 to reflect updates. The hyperparameters of the operational advisor 412 can be directed towards improved performance and/or handling multiple constraints under confliction (e.g., multiple issues to balance), for example by optimizing a penalty function that provides a weight sum of penalties associated with different constraints on different process variables. Optimization of the hyperparameters can be formulated for dynamic problems where objectives (e.g., cost objectives, emissions objectives, resource consumption objectives, resource production objectives) and/or constraints (e.g., equipment operating limits, resource consumption limits, production limits, bounds on physical conditions,) are tuned in real-time in response to user interaction and/or input. For example, the user, via the user interface 404, can provide one or more objectives for the edge device 204, the operational advisor 412 can then adjust hyperparameters in a way to meet the one or more objectives. In various embodiments, the operational advisor 412 can tune hyperparameters of the system advisor 410 and/or the domain advisor 414. Objectives and constraints used in such embodiments can be user-selected, automatically determined from equipment configuration, and/or generated intelligently by one or more AI models (e.g., an AI agent performing sentiment analysis on user interactions to determine user goals, objectives, and/or preferences for a facility).

The operational advisor 412 can also regularly scan (e.g., at predetermined time interval) the edge device 204 and highlight gaps (e.g., areas of performance improvement) and propose automated fixes (e.g., improvements). The operational advisor 412 can rank the improvements based on a calculated outcome, for example based on an amount of improvement to one or more objectives (e.g., operating costs, resource consumption, resource production, pollution reduction, emissions reduction, equipment uptime, etc.) such that higher-ranked improvements provide a greater impacted on progress towards a goal for a facility, or urgency or other consideration. For example, the operational advisor 412 can simulate the effect of the fix on the edge device 204, and rank the fixes based on the effects (e.g., based on a degree of improvement in one or more metrics, objectives, etc. of interest). Then, as a result, the operational advisor 412 can provide the user with the actionable response. For example, the actionable response can include displaying on the user interface 404 “{High} You are missing cable length stator resistance. This will prevent your application from generating reasonable values. You can find these details on the installation report. Typical values range between 10 and 20”. In this case, the operational advisor 412 has ranked the actionable response by urgency and identified the issue.

Based on the identified issues, the operational advisor 412 can guide the user in solving the issue. In this case, the operational advisor 412 can include a vision and LLM models which can access system manuals and receive information in real-time. For example, the user query processor 408 can sort the query containing “Why am I not seeing my RTU data?” to the operational advisor 412. The operational advisor 412 can then request a photo and/or video from the user which can be input and received via the user interface 404. The operational advisor 412 can then analyze the photo and/or video and identify solutions to the issue. For example, the operational advisor 412 can communication that “based on your photo, it appears your wires may be backwards”. The operational advisor 412 can also help the user troubleshoot by providing common errors (e.g., different ways the wires could be connected). To do this, the operational advisor 412 can include a context aware chat interface (e.g., LLM) to interact with the user and time-series data to provide user guides, surveillance training, operational insights extracting, and visual dashboards to the user for the edge device 204.

In various embodiments, the edge device 204 can detect a problem within the edge device 204 or the field equipment 312 and request the user query processor 408 for a solution. The user query processor 408 can then sort the request to the advisor models and generate a response. For example, the response can include creating prompts to the user to execute the solution or display results of the edge device 204 to the user or message the user via a user device.

The domain advisor 414 can provide data insights to the user based on a user's area of expertise (e.g., production, maintenance, management, operations, etc.). For example, based on a user profile and the user query containing a request for performance data of the edge device 204, the user query processor 408 can sort the query to the domain advisor 414. Based on the area of expertise, the domain advisor 414 can provide the user with training and learning assistance for the edge device 204 and/or the field equipment 312. For example, each of the areas of expertise can be assigned to a different training model (e.g., machine learning model). In various embodiments, the domain advisor 414 can include a gamified chat (e.g., LLM) to motivate user and provide a positive feedback loop to encourage human training of the system. The gamified chat can capture expert user knowledge via users with expert knowledge of the additional devices interacting with the domain advisor 414. For example, the domain advisor 414 can provide the user with 1-3 options to complete a task (e.g., accessing the set of steps via the system advisor 410). The domain advisor 414 can then ask the user to pick an option among the 1-3 options and utilize the option to further fine-tune the domain advisor 414. The domain advisor 414 can be fine-tuned with further interaction between the LLM and the user. The system advisor 410 can assign points (e.g., “experience”, “XP”, “kudos”, etc.) to incentive the user to interact with the domain advisor 414 using a reinforcement learning framework. For example, as the user uses and teaches the domain advisor 414, the domain advisor 414 can improve anticipating and completing a task (e.g., generating the actionable response for the user query).

The domain advisor 414 can also train users without any experience with the edge device 204, the field equipment 312, or, for example, the hydrocarbon site 100. The domain advisor 414 can provide a supervised learning platform and tailor the supervised learning platform based on the area of expertise. The domain advisor 414 can utilize information provided by the expert user to develop the supervised learning platform for the users without any experience. In some embodiments, the domain advisor 414 can develop a set of processors and/or resources to accelerate deployment of devices (e.g., the edge device 204). For example, the edge device 204 can include a barcode and/or QR code, and the bar code can be connected to the domain advisor 414 which can provide training to the users on the edge device 204. In some embodiments, the barcode or is also connected to the operational advisor 412 and can provide the user with set up instructions to accelerate deployment and installation of the edge device 204. The barcode can also facilitate maintenance of the edge device 204. In some embodiments, the barcode can be connected to an augmented reality (AR) platform to assist users in deployment, installation, and/or maintenance of the edge device 204.

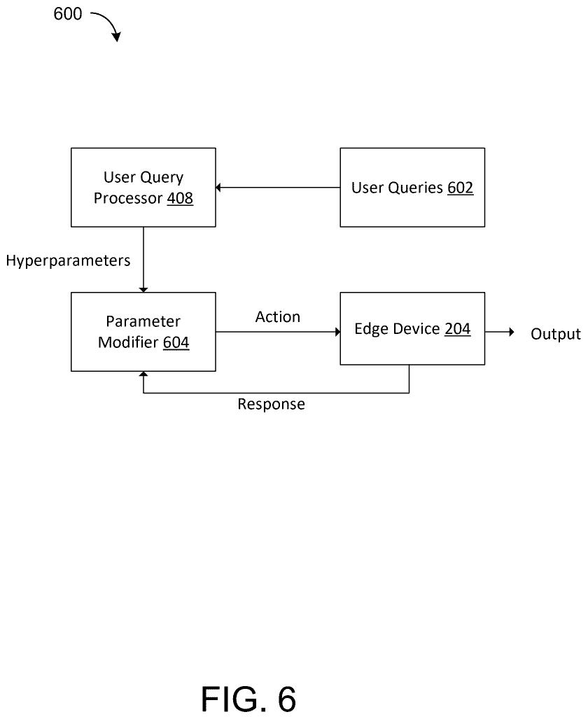

Referring now to FIG. 6, a system 600 is shown, according to some embodiments. System 600 is shown to include user queries 602, the user query processor 408, a parameter modifier 604, and the edge device 204. In some embodiments, the system 600 can be included or be implemented by at least one of the systems 200, 300, or 400. In some embodiments, the system 600 is configured to optimize the edge device 204, a converged controller (e.g., the converged controller 302), and/or a field controller (e.g., field controller 210).

The user query processor 408 can receive user queries 602 from the user. The user queries 602 can be queries, directions, requests, or instructions, among others. The user query 602 can be in a form of text, video, and/or photo. The user query processor 408 can then process the user query 602 and determine any performance and constraint requirement updates based on the user query 602. The user query processor 408 can then generate hyperparameter modifications based on the updated performance and constraint requirements. For example, a user may ask to allocate gas injection across a group of wells to maximize oil production while maintaining total volume of gas injected below a limit. In another example, the user may ask to operate pump in a specific well to maximize pump life while operating it above a specific speed. In another example, the user may ask to adjust valve in a pipeline to maintain delivery pressure within a specific range. The parameter modifier 604 can then receive the hyperparameter modifications and change the hyperparameters of the advisor models. In some embodiments, the parameter modifier 604 is included in the system advisor 410. Following modification of the hyperparameters, the advisor models can generate the actionable response (e.g., action) for the edge device 204 (e.g., shut off the field equipment 312). The edge device 204 can then generate an output to the actionable response (e.g., completing the action), and provide a result of the output to the parameter modifier 604. The result can be used by the parameter modifier 604 to further adjust hyperparameters of the advisor models to achieve a desired output by the user. In some embodiments, the desired output may not be possible to achieve within safety and/or operational constraints of, for example, the field equipment 312. In this case, the system advisor 410 may notify the user of the desired output being outside constraints of a system (e.g., the system 300). The system advisor 410 may also propose alternative strategies to achieve an output similar to the desired output.

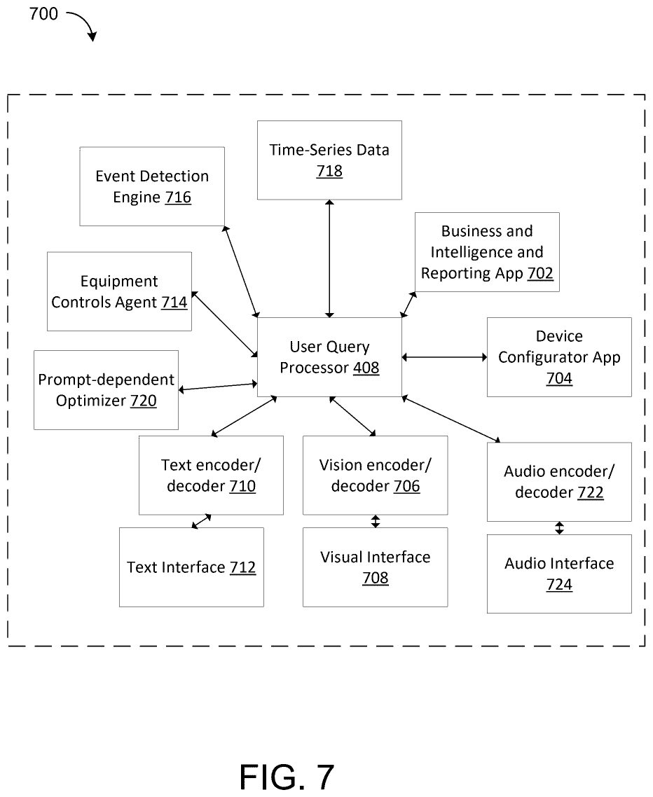

Referring now to FIG. 7, a system 700 is shown, according to some embodiments. System 600 is shown to include the user query processor 408, a business and intelligence and reporting application 702, a device configurator application 704, a vision encoder/decoder 706, a visual interface 708, a text encoder/decoder 710, a text interface 712, an equipment controls agent 714, an event detection engine 716, time-series data 718, and prompt-dependent optimizer 720. In some embodiments, the system 700 can be included or be implemented by at least one of the systems 200, 300, 400, or 600. In some embodiments, the system 700 is configured to optimize the edge device 204, a converged controller (e.g., the converged controller 302), and/or a field controller (e.g., field controller 210).

The user query processor 408 can include one or more inputs. The inputs can include documentation and existing knowledge (e.g., of the edge device 204),), manuals, training presentations, brochures, mechanical and electrical drawings, numerical models, 3D models, expert knowledge sessions, software development skills, vision and/or image data, and value creation metrics. The inputs can be used to generate the actionable response to the user query. The user query processor 408 can be a context aware multimodal LLM and be fine-tuned based on a use case. The use case can be, for example, a product portfolio and domain (e.g., domain of the edge device 204). The user query processor 408 can then utilize various components of the system 700 to generate the actionable response. For example, the business intelligence and reporting application 702 can generate reports based on the queries received, for example reports relating to predicted costs, revenue, operational insights, progress towards goals, etc. The device configurator application 704 can setup and reconfigure the device (e.g., the edge device 204) based on the user query, for example adjusting settings, point mappings, network configurations, control parameters, control logic, data labels, etc. of the edge device 204. In various embodiments, the device configurator application 704 can be included in the system advisor 410. The vision encoder/decoder 706 can encode and decode photos and videos contained in the user query. The vision encoder/decoder 706 can facilitate processing of the photos and videos. The photos and videos (e.g., visual query) can be received via a visual interface 708 which can be included in the user interface 404. The visual query can be received in response to providing prompts to the user (e.g., regarding the edge device 204). The photos and videos can be of writing, various components of the edge device 204, etc.

The user query processor 408 can also utilize and/or include the text encoder/decoder 710 in response to receiving a free-text user query. The free-text user query can be a response to a prompt provided by the, for example, user query processor 408. The text encoder/decoder 710 can encode and decode text string and characters contained in the user query. The text encoder/decoder 710 can tokenize the text string for processing and identify a context of the text string. The text encoder/decoder 710 can communicate with the text interface 712 which can be included in the user interface 404. The text interface 712 can receive text strings regarding data, events, device configuration, etc. from the user. The text interface 712 can also provide prompts to the user as well as providing the gamified chat of the system 400 to the user.

An equipment controls agent 714 can be included in the operational advisor 412, and can control equipment (e.g., field equipment 312, edge device 204) in response to the actionable response generated by the user query processor 408. The equipment control agent 714 can be AI models or traditional control models trained (e.g., developed) for specific type of equipment (e.g., electrical submersible pump) and deployed on individual wells (e.g., the field equipment 312). Based on a user prompt or instruction, the equipment control agent 714 may manipulate (e.g., control, operate) the equipment. For example, if a user asks to increase the speed of the pump in a specific well, the user query processor 408 redirects the query to the equipment control agent 714 which can then increase the speed of the pump. An event detection engine 716 can detect any issues, environmental events, etc. with, for example, the edge device 204. The event detection engine 716 may be a software application consisting of AI and non-AI models designed to monitor equipment, well, asset, device, etc. and detect, identify, and raise alarms indicating various types of events, anomalies, or issues. For example, the event detection engine 716 designed for pumps can detect issues overheating, gas interference, etc. with the pumps. As another example, the event detection engine 716 can identify anomalies in a pipeline flow such as leakage. As another example, the event detection engine 716 can detects faults in sensors (e.g., the sensor 308) or edge devices (e.g., the edge device 204) of an equipment (e.g., the field equipment 312). The user query processor 408 can also receive time-series data which can be data in real-time from, for example, the edge device 204, time stamped data, etc. In this case, the user query processor 408 can provide the user with continuous updates, as well as continuous recommendations for adjustments to the edge device 204 for improved performance. A prompt-dependent optimizer 720 can optimize (e.g., modify parameters) the, for example, edge device 204 based on the user prompt received by the user query processor 408. Based on the user's prompt in natural language (e.g., free-text), the prompt-dependent optimizer 720 can generate an appropriate objective function or change an objective function which modifies behavior of a relevant AI agent (e.g., model) such as the equipment controls agents 714. For example, the user prompt can include speeding up production of gas. The prompt-dependent optimizer 720 can then calculate parameter modifications and implement the parameter modifications on the edge device 204. In some embodiments, the prompt-dependent optimizer 720 is the parameter modifier 604.

The user query processor 408 can also utilize and/or include the audio encoder/decoder 722 in response to receiving a user query including audio data. The user query can include audio data including a response to a prompt provided by the, for example, user query processor 408. The audio encoder/decoder 722 can encode and decode at least one of an amplitude, frequency, or channels of the audio data contained in the user query. The audio encoder/decoder 722 can tokenize the audio data for processing and identify a context of the audio data. The audio encoder/decoder 722 can communicate with the audio interface 724 which can be included in the user interface 404. The audio interface 724 can receive audio regarding data, events, device configuration, etc. from the user. The audio interface 724 can also provide prompts to the user as well as providing the gamified chat of the system 400 to the user.

In some implementations, the user query processor 408 can receive a user query including at least one of structured or unstructured data. For example, the user query can include free-text data and text associated with fields provided by the user query processor 408. The user query processor 408 can encode and decode the at least one of structured or unstructured data received in response to a prompt provided by the user query processor 408. The user interface 404 can include at least one interface to provide prompts and receive at least one of structured or unstructured data in response to prompts. The at least one of structured or unstructured data can include one or more types of data, such as audio, visual, video, or haptic, among others.

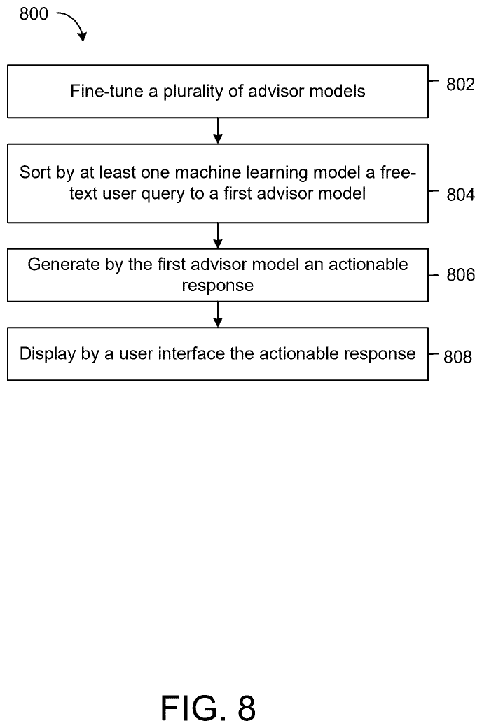

Now referring to FIG. 8, each block of method 800, described herein, includes a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, method 800 is described, by way of example, with respect to the system 400 and/or the system 600 and/or the system 700. However, these methods may additionally or alternatively be executed by any one system, or any combination of systems, including, but not limited to, those described herein.

The method 800 can be directed towards generating and displaying an actionable response in response to a user query. At block 802, a plurality of advisor models is fine-tuned. The plurality of advisor models can be fine-tuned through user interactions or being fed information such as system manuals or data relating to oil-and-gas equipment (e.g., field equipment 312). The plurality of advisor models can perform different types of advisor operations (e.g., training a user). At block 804, the method can include sorting, by at least one machine learning model, a free-text user query to a first advisor model. The free-text user query can be sorted based on a content of the user query. The free-text user query can thus be sorted to one of the plurality of advisor models based on the content and a type of advisor operations that the advisor model performs. At block 806, the first advisor model can generate an actionable response. The actionable response can include instructions for the user, instructions for the oil-and-gas equipment, etc. The actionable response can be a response to the free-text user query. At block 808, the actionable response can be displayed on a user interface (e.g., the user interface 404). In this case, the actionable response includes directions to the user (e.g., reconnecting wires of a component of the oil-and-gas equipment).

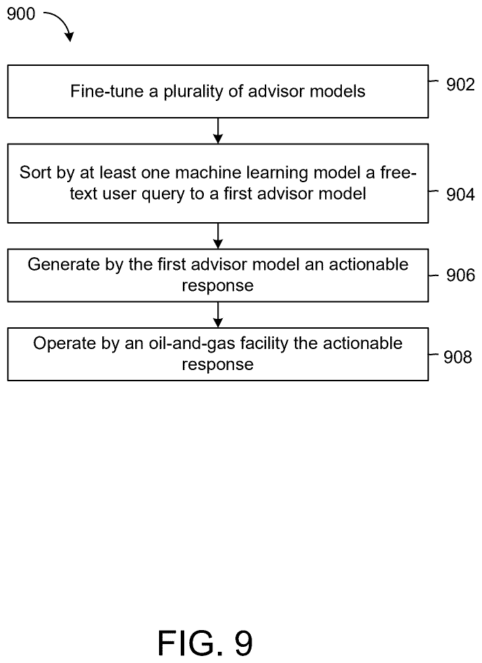

Now referring to FIG. 9, each block of method 900, described herein, includes a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, method 900 is described, by way of example, with respect to the system 400 and/or system 600 and/or the system 700. However, these methods may additionally or alternatively be executed by any one system, or any combination of systems, including, but not limited to, those described herein.

The method 900 can be directed towards generating and displaying an actionable response in response to a user query. At block 902, a plurality of advisor models are fine-tuned. The plurality of advisor models can be fine-tuned through user interactions or being fed information such as system manuals or data relating to oil-and-gas equipment (e.g., field equipment 312). The plurality of advisor models can perform different types of advisor operations (e.g., training a user). At block 904, the method can include sorting, by at least one machine learning model, a free-text user query to a first advisor model. The free-text user query can be sorted based on a content of the user query. The free-text user query can thus be sorted to one of the plurality of advisor models based on the content and a type of advisor operations that the advisor model performs. At block 906, the first advisor model can generate an actionable response. The actionable response can include instructions for the user, instructions for the oil-and-gas equipment, etc. The actionable response can be a response to the free-text user query. At block 908, the actionable response can be operated by an oil-and-gas facility (e.g., the hydrocarbon site 100). For example, responsive to the actionable response being adjusting a flow rate of oil, the oil-and-gas facility executes the actionable response.

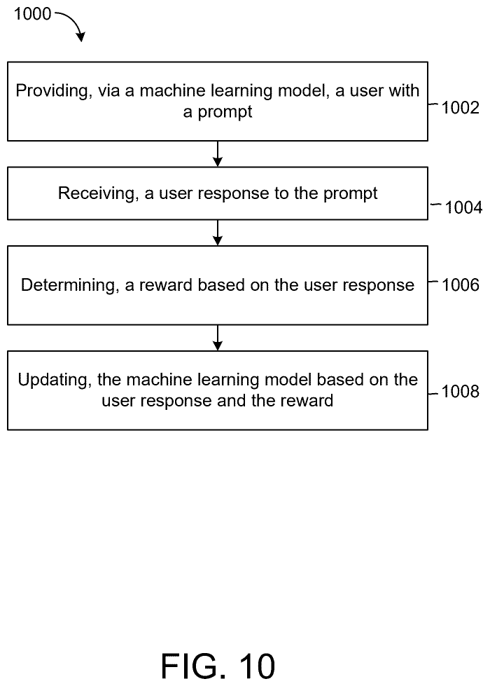

Now referring to FIG. 10, each block of method 1000, described herein, includes a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, method 1000 is described, by way of example, with respect to the system 400 and/or the system 600 and/or the system 700. However, these methods may additionally or alternatively be executed by any one system, or any combination of systems, including, but not limited to, those described herein.

In some embodiments, the method 1000 can be executed by the domain advisor 414. At 1002, the method 1000 can include providing a user with a prompt via a machine learning model. The prompt can be a direction to answer a question or pick an option given a plurality of options in response to a situation. For example, the prompt can include an oil-and-gas facility scenario, and the user is asked to pick an option based on the scenario. At 1004, a user response to the prompt is received. The user response can be free-text or a selection of one of the options. At 1006, a reward can be determined based on the user response. The reward can be displayed on a user interface to incentive the user to continue providing user responses to the prompts. The reward can be in a form of points or experience. The reward can be determined by calculating a difference between the user response and the expected response. At 1008, the machine learning model can be updated based on the user response and the reward. For example, based on the difference, the machine learning model can be updated to provide different prompts (e.g., harder prompts compared to a previous prompt).

By using a context aware multimodal LLM as well as multiple advisor models, the teachings herein can culminate in online control and monitoring of industrial equipment (e.g., various pumps, actuators, etc. for oil-and-gas facilities as shown in FIGS. 1-3) in accordance with continual optimization of an edge device, converged controller, or field controller as described herein. The teachings here can therefore provide training to users, troubleshoot, optimize, develop applications, and capture expert knowledge of a wide variety of control and other applications for controls, including for control of oil-and-gas equipment.

### Configuration of Exemplary Embodiments

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining can be stationary (i.e., permanent or fixed) or moveable (i.e., removable or releasable). Such joining can be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (i.e., directly coupled), the generic definition of “coupled” provided above is modified by the plain language meaning of the additional term (i.e., “directly coupled” means the joining of two members without any separate intervening member), resulting in a narrower definition than the generic definition of “coupled” provided above. Such coupling can be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element can be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

Although the figures and description can illustrate a specific order of method steps, the order of such steps can differ from what is depicted and described, unless specified differently above. Also, two or more steps can be performed concurrently or with partial concurrence, unless specified differently above. Such variation can depend, for example, on the software and hardware systems chosen and on designer choice. All such variations are within the scope of the disclosure.

It is important to note that the construction and arrangement of the apparatus as shown in the various exemplary embodiments is illustrative only. Additionally, any element disclosed in one embodiment can be incorporated or utilized with any other embodiment disclosed herein. Although only one example of an element from one embodiment that can be incorporated or utilized in another embodiment has been described above, it should be appreciated that other elements of the various embodiments can be incorporated or utilized with any of the other embodiments disclosed herein.

What is claimed is:

1. A system, comprising:
an edge device; and
a computing platform configured to assist operation of the edge device comprising a user interface, the computing platform comprising one or more processors and one or more non-transitory computer-readable media storing program instructions that, when executed by the one or more processors, cause the one or more processors to perform operations comprising:
fine-tuning a plurality of advisor models to perform different types of advisor operations for an oil-and-gas facility using data relating to oil-and-gas equipment;
in response to receiving a user query via the user interface, sorting the user query to a first advisor model by selecting, by at least one machine learning model, the first advisor model from the plurality of advisor models based on a content of the user query;
generating, by the first advisor model, an actionable response to the user query; and
causing the oil-and-gas facility to operate in accordance with the actionable response.

2. The system of claim 1, wherein the plurality of advisor models comprise a system advisor model, the system advisor model comprising a machine learning model configured to perform advisor operations comprising configuring the edge device and assisting in developing applications for the edge device.

3. The system of claim 1, wherein the plurality of advisor models comprise an operational advisor model, the operational advisor model comprising a machine learning model configured to perform advisor operations comprising proposing improvements to and monitoring the edge device.

4. The system of claim 1, wherein the plurality of advisor models comprise a domain advisor model, the domain advisor model comprising a machine learning model configured to perform advisor operations comprising providing training for the edge device to users, the machine learning model being continuously updated based on feedback from the training.

5. The system of claim 1, wherein the at least one machine learning model is a context aware multimodal large language model (LLM) and the user query comprises at least one of a free-text user query, a visual user query, or an audio user query.

6. The system of claim 5, wherein the user interface comprises a text interface, the at least one machine learning model to provide prompts to a user and receive the free-text user query via the text interface.

7. The system of claim 5, wherein the user interface comprises a visual interface, the at least one machine learning model to provide prompts to a user and receive the visual user query via the visual interface.

8. The system of claim 5, wherein the user interface comprises an audio interface, the at least one machine learning model to provide prompts to a user and receive the audio user query via the audio interface.

9. The system of claim 1, wherein causing the oil-and-gas facility to operate in accordance with the actionable response comprises changing, based on the actionable response, a setting used by the edge device and controlling, by the edge device, equipment of the oil-and-gas facility using the setting.

10. The system of claim 1, wherein the actionable response comprises parameter modifications for the edge device, the parameter modifications based on hyperparameters of the first advisor model.

11. A method, comprising:
fine-tuning a plurality of advisor models to perform different types of advisor operations for an oil-and-gas facility using data relating to oil-and-gas equipment;
receiving a user query via a user interface;
sorting the user query to a first advisor model by selecting, by at least one machine learning model, the first advisor model from the plurality of advisor models based on content of the user query;
generating, by the first advisor model, an actionable response to the user query; and
operating, an edge device of the oil-and-gas facility, in accordance with the actionable response.

12. The method of claim 11, wherein the plurality of advisor models comprise a system advisor model, the system advisor model comprising a machine learning model configured to perform advisor operations comprising configuring the edge device and assisting in developing applications for the edge device.

13. The method of claim 11, wherein the plurality of advisor models comprise an operational advisor model, the operational advisor model comprising a machine learning model configured to perform advisor operations comprising proposing improvements to and monitoring the edge device.

14. The method of claim 11, wherein the plurality of advisor models comprise a domain advisor model, the domain advisor model comprising a machine learning model configured to perform advisor operations comprising providing training for the edge device to users, the machine learning model being continuously updated based on feedback from the training.

15. The method of claim 11, wherein the at least one machine learning model is a context aware multimodal large language model (LLM) and the user query comprises at least one of a free-text user query, a visual user query, or an audio user query.

16. The method of claim 15, wherein the user interface comprises at least one of:
a text interface, the at least one machine learning model to provide prompts to a user and receive the free-text user query via the text interface,
a visual interface, the at least one machine learning model to provide the prompts to the user and receive the visual user query via the visual interface, or
an audio interface, the at least one machine learning model to provide the prompts to the user and receive the audio user query via the audio interface.

17. The method of claim 11, wherein to cause the oil-and-gas facility to operate in accordance with the actionable response, the method further comprises:
changing, based on the actionable response, a setting used by the edge device; and
controlling, by the edge device, equipment of the oil-and-gas facility using the setting.

18. The method of claim 11, wherein the actionable response comprises parameter modifications for the edge device, the parameter modifications based on hyperparameters of the first advisor model.

19. A system, comprising:
an edge device;
a user interface; and
a computing platform configured to assist operation of the edge device, the computing platform comprising one or more processors and one or more non-transitory computer-readable media storing program instructions that, when executed by the one or more processors, cause the one or more processors to perform operations comprising:
in response to receiving a user query from the user interface, providing, using at least one machine learning model, the user query to an advisor model of a plurality of advisor models based at least partially on a content of the user query, the plurality of advisor models to perform different types of advisor operations for an oil-and-gas facility using data relating to oil-and-gas equipment;
generating, by the advisor model, an actionable response to the user query; and
causing the user interface to display the actionable response.

20. The system of claim 19, wherein the actionable response includes at least directions to a user.
